(19) United States
(12) Patent Application Publication
(10) Pub. No.: US 2026/0112276 A1
(43) Pub. Date: Apr. 23, 2026

(54) METHODS AND SYSTEMS FOR VEHICLE RECOVERY

(71) Applicant: HONEYWELL INTERNATIONAL INC., Charlotte, NC (US)

(72) Inventors: Srilakshmi Kurudi, Bangalore (IN); Gobinathan Baladhandapani, Madurai (IN); Karthikeyan M, Madurai (IN); Sivakumar Kanagarajan, Bangalore (IN)

(73) Assignee: HONEYWELL INTERNATIONAL INC., Charlotte, NC (US)

(21) Appl. No.: 18/980,895

(22) Filed: Dec. 13, 2024

(30) Foreign Application Priority Data
Oct. 18, 2024 (IN) 202411079207

(51) Int. Cl. G08G 5/34; B64D 1/02; B64U 10/13; B64U 101/66; B64U 101/69; G08G 5/23

(52) U.S. Cl. CPC G08G 5/34; B64D 1/02; G08G 5/23; B64U 10/13; B64U 2101/66; B64U 2101/69; B64U 2201/20

(57) ABSTRACT

Cloud-based systems and methods are provided for assisting recovery or salvage operations for an aircraft or other vehicle encountering an anomalous condition. An exemplary method involves obtaining status information indicative of a current state of the vehicle en route to a destination, determining an alternative destination for the vehicle different from the destination based at least in part on the current state of the vehicle and one or more salvage criteria associated with a respective salvage strategy, determining an alternative route to the alternative destination for the respective salvage strategy based at least in part on the current state of the vehicle, calculating one or more recovery performance metrics associated with the respective salvage strategy, and providing graphical indicia of the respective one or more recovery performance metrics associated with the respective salvage strategies of the plurality of salvage strategies.

### CROSS REFERENCE TO RELATED APPLICATION

This application claims priority to India Provisional Patent Application No. 202411079207, filed Oct. 18, 2024, the entire content of which is incorporated by reference herein.

### TECHNICAL FIELD

The subject matter described herein generally relates to vehicle systems, and more particularly, embodiments of the subject matter relate to facilitating salvage or recovery operations when deviating from a route to an intended destination in response to an anomalous condition.

### BACKGROUND

Vehicles are frequently operated in accordance with a predefined route to a particular intended destination desired by a vehicle operator. However, in some situations, a vehicle may need to deviate from a planned route or otherwise divert to a different destination. For example, in the event of an emergency, adverse meteorological conditions, or the like, it may be desirable to deviate from traveling en route to the intended destination for purposes of preserving the vehicle, payload, passengers, and/or the like. However, deviating from an originally planned route may require consideration of numerous pieces of information to facilitate continued safe operation, and the time-sensitive nature can increase the stress on a vehicle operator, which, in turn, may reduce situational awareness and/or increase the likelihood of human error. Accordingly, it is desirable to reduce the mental workload of a vehicle operator when diverting from travel en route to a planned destination and improve the likelihood of preserving and recovering the vehicle, payload, passengers, and/or the like.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

Cloud-based computing systems and related methods and apparatus are provided for assisting operation of a vehicle encountering an anomalous condition en route to a destination. An exemplary method involves obtaining, via one or more systems onboard the vehicle, status information indicative of a current state of the vehicle, for a respective salvage strategy of a plurality of salvage strategies, determining an alternative destination for the vehicle different from the destination based at least in part on the current state of the vehicle and one or more salvage criteria associated with the respective salvage strategy, determining an alternative route to the alternative destination based at least in part on the current state of the vehicle, and calculating one or more recovery performance metrics associated with the alternative route based at least in part on the current state of the vehicle, and providing, on a graphical user interface (GUI) display associated with the vehicle, graphical indicia of the respective one or more recovery performance metrics associated with the respective salvage strategies of the plurality of salvage strategies.

Other desirable features and characteristics of the subject matter described herein will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a block diagram illustrating a computing system configurable to support a cloud-based monitoring service in connection with operation of a vehicle such as an aircraft in accordance with one or more exemplary embodiments;

FIG. 2 is a flow diagram of a recovery process suitable for implementation by monitoring service in the computing system of FIG. 1 in an exemplary embodiment; and

FIGS. 3-6 depict an exemplary sequence of graphical user interface (GUI) displays suitable for presentation in connection with the recovery process of FIG. 2 in accordance with one or more exemplary embodiments.

### DETAILED DESCRIPTION

The following detailed description is merely exemplary in nature and is not intended to limit the subject matter of the application and uses thereof. Furthermore, there is no intention to be bound by any expressed or implied theory presented in the preceding technical field, background, brief summary, or the following detailed description.

Embodiments of the subject matter described herein generally relate to systems and methods for assisting a vehicle operator in response to occurrence of an anomalous event or condition that may inhibit the ability of a vehicle traveling en route to an intended destination from successfully reaching the destination. For purposes of explanation, the subject matter is described herein primarily in the context of aircraft, such as vertical take-off and landing (VTOL) aircraft, urban air mobility (UAM) vehicles or other unmanned aerial vehicles (UAVs); however, it should be appreciated the subject matter is not necessarily limited to use with aircraft and may be implemented in an equivalent manner for other types of vehicles (e.g., automotive vehicles, marine vessels, or the like).

In response to an anomalous condition that may require a potential diversion, different potential salvage strategies are utilized to different alternative destinations based on the current vehicle state and the respective recovery or salvage criteria associated with the respective salvage strategy. In this regard, a given salvage strategy may have one or more different recovery or salvage criteria associated therewith that the respective salvage strategy is configured to minimize, maximize, optimize or otherwise prioritize relative to other destination selection criteria or route selection criteria when identifying an alternative destination and corresponding route to that alternative destination in accordance with the respective salvage strategy. For example, in the context of a UAM or UAV application, a vehicle recovery salvage strategy may have one or more salvage criteria associated therewith that are configured to maximize the probability of successfully landing and recovering the aircraft with minimal damage to the aircraft and prioritize viability of the aircraft over payload, while on the other hand, a payload recovery salvage strategy may have one or more salvage criteria associated therewith that are configured to maximize the probability of successfully preserving and recovering the cargo or payload being transported by the aircraft and prioritize minimizing damage to the payload over viability of the aircraft. Other salvage strategies may be configured to prioritize passengers, minimize recovery time, minimize distance from the intended destination, minimize remaining amount of travel time, minimize distance from the original departure location, and/or the like.

For each potential salvage strategy, an alternative destination for the aircraft in a vicinity of the aircraft or otherwise within range of the aircraft is automatically selected or otherwise identified from among one or more potential landing destinations by scoring or otherwise ranking the respective destinations in accordance with the recovery or salvage criteria associated with that respective salvage strategy. After selecting the alternative destination for a particular salvage strategy, an alternative route from the current location or state of the aircraft to that alternative destination is automatically constructed or otherwise determined. In this regard, in some implementations, the potential routes to the respective potential landing destinations may be scored or otherwise ranked in accordance with the recovery or salvage criteria associated with that respective salvage strategy in connection with scoring the respective landing destination, such that the resulting combination of alternative destination and alternative route thereto satisfies or otherwise optimizes the recovery or salvage criteria associated with that respective salvage strategy.

Once an alternative route to an alternative destination is identified for a respective salvage strategy, in exemplary implementations described herein, one or more recovery performance metrics are calculated or otherwise determined based on the current state of the aircraft, the current and/or forecasted meteorological conditions along the alternative route and/or at the alternative destination, and potentially other data or factors, including, but not limited to terrain data, obstacle data, environmental data, air traffic data, historical data and/or the like pertaining to the alternative route to the alternative destination. In this regard, the recovery performance metrics are generally indicative of a probability of success or another particular outcome associated with one or more recovery parameters or salvage criteria. For example, given the current geographic location and altitude of the aircraft and other state information for the aircraft (e.g., the current engine state, the current rotor state, the current payload, the current fuel or battery power remaining, and/or the like) and the current meteorological conditions, the probability of the aircraft successfully traveling the alternative route and landing at the alternative destination without damage to the aircraft, the probability of preserving the payload or cargo, the probability of preserving the passengers, and/or the like.

After identifying and analyzing the different potential salvage strategies, a graphical user interface (GUI) display is provided to an operator of the aircraft that includes graphical indicia of the different potential salvage strategies and the respective recovery performance metrics associated therewith. For example, the GUI display may include a listing of each potential salvage strategy and its associated probability of success with respect to the vehicle, the payload, the passengers, and/or the like. Thus, an aircraft operator may quickly assess the different potential salvage strategies and different “what if?” scenarios to identify the particular salvage strategy most likely to achieve the desired level of performance with respect to the particular recovery or salvage criteria of interest.

In one or more exemplary implementations, a cloud-based monitoring service receives current status information from aircraft substantially in real-time and analyzes the current status information with respect to the aircraft's flight plan while also analyzing the current meteorological conditions, current airspace restrictions, current air traffic and/or the like to detect or otherwise identify an anomalous condition indicative of a potential deviation from the aircraft's current travel en route to the planned destination. For example, the monitoring service may detect or otherwise identify when the flight plan conflicts with a temporary flight restriction or may otherwise be inhibited by meteorological conditions, air traffic or other external factors. In addition to monitoring external factors or other data sources external to the aircraft, the monitoring service may similarly analyze the current aircraft state information to detect or otherwise identify when the likelihood or probability of the aircraft reaching the planned destination falls below a threshold value based on the current status of the aircraft, such as, for example, when the amount of battery energy or fuel remaining is less than an expected amount required to reach the planned destination based on the current meteorological conditions, historical flight data, and/or the like. In this regard, it should be appreciated that in practice, there are any number of different data sources that may be monitored to identify an anomalous condition or other potential diversion condition, and the subject matter described herein is not limited to an particular type or combination of data sources and logic for detecting a potential diversion condition.

In response to identifying an anomalous condition, the cloud-based monitoring service automatically identifies different alternative destinations and routes associated with the different potential salvage strategies and calculates or otherwise determines recovery performance metrics associated with the respective salvage strategies. The monitoring service transmits or otherwise provides indicia of the anomalous condition and the potential salvage strategies to a device or system associated with the aircraft for rendering a GUI display including graphical indicia of the recovery performance metrics associated with the potential salvage strategies for analysis by the aircraft operator. In exemplary implementations, the GUI display is interactive to allow the aircraft operator to select a particular salvage strategy from the listing of potential salvage strategies to preview the respective alternative destination and alternative route thereto associated with the respective salvage strategy. When the aircraft operator identifies the salvage strategy that achieves the desired performance, the GUI display includes a GUI element manipulable the aircraft operator to select or otherwise activate that salvage strategy, which, in turn, results in the monitoring service automatically transmitting or otherwise providing the alternative route information and corresponding commands or instructions to a flight management system (FMS) or other control system onboard the aircraft to reprogram any autonomous or automated functionality of the aircraft to automatically fly the alternative route to land at the alternative destination associated with the selected salvage strategy.

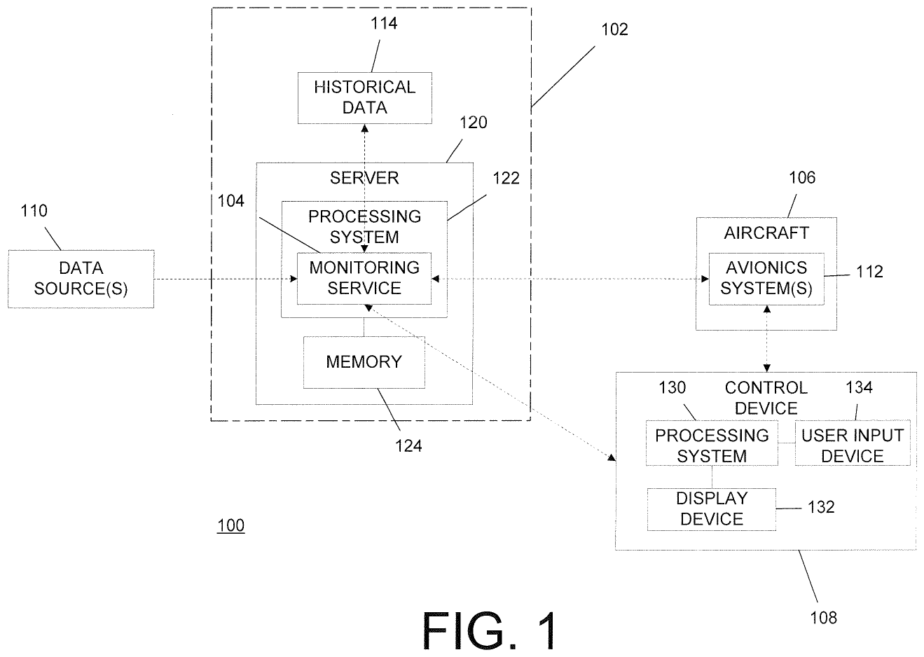

FIG. 1 depicts an exemplary system 100 that includes a cloud-based computing system 102 capable of supporting a monitoring service 104 configurable to provide graphical indicia of different potential salvage strategies and their associated recovery performance metrics for a vehicle 106 in response to an anomalous condition that may require the vehicle 106 to deviate from a current route of travel to an intended destination. For purposes of explanation, the subject matter is described herein in the context of the vehicle 106 being realized as an aircraft such as an UAV or other VTOL that may be remotely operated by a user of a remote control device 108. That said, it should be appreciated that the subject matter described herein is not intended to be limited to any particular type of vehicle 106 or device 108 where graphical indicia may be provided.

In exemplary implementations, any number of different external systems, devices or other data sources 110 may be communicatively coupled to the cloud-based computing system 102 over any sort of communications network, such as, for example, the Internet, a cellular network, a mobile network, a local area network (LAN), a wide area network (WAN), or any other suitable telecommunications network. For example, in practice, any number of external systems may be communicatively coupled to the cloud-based computing system 102 to provide information pertaining to operation of the aircraft 106 being monitored. In various implementations, the external systems include one or more weather monitoring system(s) (e.g., a Doppler radar monitoring system, a collaborative convective forecast product (CCFP) or national convective weather forecast (NCWF) system, an infrared satellite system, etc.), reporting systems (e.g., a Notice to Airmen (NOTAM) system, a Pilot Reporting (PIREP) system, or the like), broadcast systems (e.g., Automated Terminal Information Service (ATIS), an Automatic Dependent Surveillance-Broadcast (ADS-B) system, or the like), communications systems (e.g., a controller-pilot data link system (CPDLC), an Air Traffic Control (ATC) system, or the like) or other external systems suitable for providing current or real-time information pertaining to operation of an aircraft 106 within a particular geographic region. Additionally, the external data sources 110 may include one or more databases, such as, for example, an airport database, a terrain database, an obstacle database and/or the like. It should be appreciated that the subject matter described herein is not limited to any particular type or number of data sources from which supplemental information may be obtained by the monitoring service 104.

In addition to data sources 110, in exemplary implementations, the monitoring service 104 at the cloud-based computing system 102 is configurable to obtain status information indicative of the current state of the aircraft 106 from one or more systems 112 that are located onboard or otherwise associated with the aircraft 106. In this regard, in an aviation context, the onboard systems 112 generally represents any sort of avionics system capable of providing data and/or information regarding the operation of the aircraft 106, such as, for example, a flight management system (FMS), a navigation system, a communications system, an autopilot system, an autothrust system, a weather system, an air traffic management system, a radar system, a traffic avoidance system, hydraulics systems, pneumatics systems, environmental systems, electrical systems, engine systems, trim systems, lighting systems, crew alerting systems, electronic checklist systems, an electronic flight bag and/or another suitable avionics system. Although FIG. 1 depicts the monitoring service 104 receiving the current status information from the onboard avionics system(s) 112 directly over a communications network, in alternative implementations, the monitoring service 104 may receive the current status information from the onboard avionics system(s) 112 indirectly via the remote control device 108.

The control device 108 generally represents an electronic device capable of communicating with one or more avionics systems 112 associated with the aircraft 106 to manage, influence or otherwise control operation of the aircraft 106. In this regard, in a UAV or VTOL context, the control device 108 may be realized as a flight controller or other remote controller associated with the aircraft 106. That said, in other implementations, the control device 108 could be realized as any sort of client electronic device, such as, for example, an electronic flight bag (EFB), a mobile phone, a smartphone, a tablet computer, a laptop computer, and/or the like. In yet other embodiments, the control device 108 could be realized as a multi-function control and display unit (MCDU) or another hardware component that is incorporated with the flight deck or cockpit of the aircraft 106. In exemplary implementations, the control device 108 generally includes an electronic display device 132 capable of graphically presenting data and/or information along with one or more user input devices 134 capable of receiving input from the user of the control device 108, and a processing system 130 that includes or is otherwise coupled to a data storage element having programming instructions or code that, when read and executed, cause the processing system to generate one or more GUI displays on the display device 132 and support the subject matter described herein.

Still referring to FIG. 1, the illustrated cloud-based computing system 102 includes at least one server 120, which generally represents a server computing device or system that includes at least one processing system 122, which generally represents the control module or other hardware suitably configured to support the monitoring service 104 and other operations of the server 120 described herein. In this regard, the processing system 122 may include or otherwise be realized using a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The processing system 122 includes or otherwise accesses a data storage element 124 (or memory), which may be realized as any sort of non-transitory short or long term storage media capable of storing programming instructions for execution by the processing system 122. The code or other computer-executable programming instructions, when read and executed by the processing system 122, cause the processing system 122 to support or otherwise perform certain tasks, operations, functions, and/or processes described herein. Depending on the embodiment, the memory 124 may be physically realized using random-access memory (RAM), read-only memory (ROM), flash memory, registers, a hard disk, or another suitable data storage medium known in the art or any suitable combination thereof.

In exemplary implementations, the computer-executable programming instructions are executed by the processing system 122 to generate, execute, or otherwise implement the monitoring service 104 that is configurable to receive information or data indicative of the current state of the aircraft 106 from one or more onboard systems 112 and analyze the current state of the aircraft 106 with respect to a flight plan for the aircraft 106 and/or supplemental information obtained from one or more other data sources 110 to detect or otherwise identify an anomalous condition that may influence the ability of the aircraft 106 to complete execution of the flight plan and land at its intended destination. In response to an anomalous condition, the monitoring service 104 automatically identifies different alternative destinations for the aircraft 106 in accordance with different potential salvage strategies and automatically determines corresponding routes for reaching those alternative destinations from the current aircraft location in accordance with the respective salvage strategy. For each salvage strategy, the monitoring service 104 utilizes supplemental information from one or more data sources 110 to calculate or otherwise determine values for one or more recovery performance metrics for that salvage strategy given the current state of the aircraft 106. In this regard, in some implementations, the cloud-based computing system 102 may also store or otherwise maintain historical data 114 pertaining to historical flights and/or prior execution of salvage strategies identified by the monitoring service 104 to dynamically calculate or otherwise determine the probability of a particular salvage strategy achieving a particular outcome that may be desired by an operator of the aircraft 106.

In practice, information characterizing the different potential salvage strategies and the respective recovery or salvage criteria associated therewith may be stored or otherwise maintained in the memory 124 for reference by the monitoring service 104. In this regard, a given salvage strategy may be defined by any type, number or combination of different recovery or salvage criteria as well as other preferences that may be associated with a particular user or operator, a particular make or model of aircraft 106 and/or the like.

As described in greater detail below, after identifying different potential salvage strategies and determining corresponding recovery performance metrics, the monitoring service 104 transmits or otherwise provides indication of the anomalous condition to the control device 108 along with commands, instructions, data or other information suitable for execution by the processing system 130 to render or otherwise generate a GUI display on the display device 132 that includes graphical indicia of the different potential salvage strategies and their respective recovery performance metric values. The aircraft operator may utilize the GUI display to analyze and preview the different potential salvage strategies and select the salvage strategy identified by the monitoring service 104 that is most likely to achieve the operator's objectives. In response to selection of a particular salvage strategy for execution, the monitoring service 104 transmits or otherwise provides corresponding commands, instructions, data or other information to one or more avionics systems 112 onboard the aircraft 106 (either directly over a communications network or indirectly via the control device 108). In this regard, in exemplary implementations, the monitoring service 104 is configurable to program or otherwise configure the onboard avionics system(s) 112 to autonomously operate the aircraft 106 en route to the alternative destination associated with the selected salvage strategy along the alternative route identified by the monitoring service 104 without requiring the aircraft operator to modify the flight plan or otherwise reprogram a FMS, an autopilot system and/or the like.

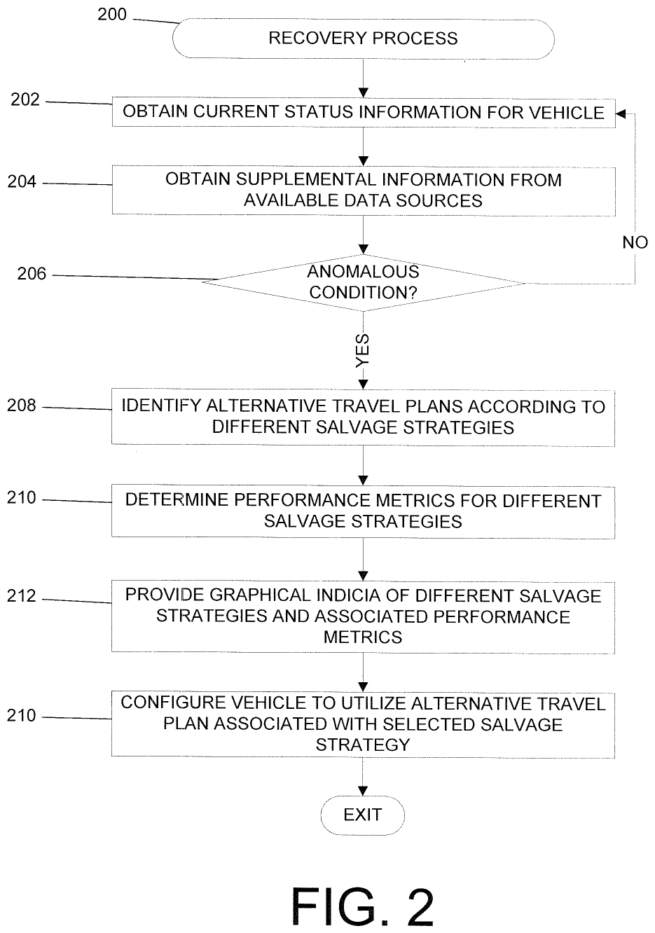

FIG. 2 depicts an exemplary embodiment of a recovery process 200 suitable for implementation by a monitoring service associated with a vehicle, such as a cloud-based monitoring service 104 monitoring operation of an aircraft 106. The various tasks performed in connection with the illustrated process may be implemented using hardware, firmware, software executed by processing circuitry, or any combination thereof. For illustrative purposes, the following description may refer to elements mentioned above in connection with FIG. 1. In practice, portions of the recovery process 200 may be performed by different elements of the computing system 100. That said, exemplary embodiments are described herein in the context of the recovery process 200 being primarily performed by the monitoring service 104 at the cloud-based computing system 102. It should be appreciated that the recovery process 200 may include any number of additional or alternative tasks, the tasks need not be performed in the illustrated order and/or the tasks may be performed concurrently, and/or the recovery process 200 may be incorporated into a more comprehensive procedure or process having additional functionality not described in detail herein. Moreover, one or more of the tasks shown and described in the context of FIG. 2 could be omitted from a practical embodiment of the recovery process 200 as long as the intended overall functionality remains intact.

The illustrated recovery process 200 receives or otherwise obtains current status information for a vehicle along with supplemental information available from one or more additional different data sources and continually analyzes or otherwise monitors the current vehicle status information with respect to the available supplemental information for indication of a potential anomalous condition with respect to continued operation of the vehicle (tasks 202, 204, 206). In exemplary implementations, one or more avionics systems 112 onboard the aircraft 106 are configurable to transmit, upload or otherwise provide information indicative of the current state of the aircraft 106 to the monitoring service 104 at the cloud-based computing system 102 periodically or asynchronously on a substantially continual basis, such that the monitoring service 104 obtains information characterizing the current state of the aircraft 106 substantially in real-time. For example, a FMS or similar system associated with the aircraft 106 may upload or otherwise provide information indicative of the current flight plan being flown by the aircraft 106 along with status information indicative of the current aircraft configuration or operational state (e.g., current engine status, current battery status, current fuel remaining, etc.) as well as the current spatial progress of the aircraft 106 traveling along the flight plan, including, but not limited to, the current geographic location of the aircraft 106, the current altitude of the aircraft 106, the current speed of the aircraft 106, the current heading of the aircraft 106, and/or the like. Additionally, the monitoring service 104 may continually receive or otherwise obtain supplemental information from different data sources 110 that are available or otherwise connected to the cloud-based computing system 102 over a communications network. For example, the monitoring service 104 may obtain meteorological information from an external data source 110 indicative of the current or forecasted meteorological conditions along the route associated with the aircraft 106 or otherwise pertaining to a geographic area encompassing the current geographic location of the aircraft 106 and/or the flight plan route. Similarly, the monitoring service 104 may obtain air traffic information, airspace restriction information, PIREPs information, NOTAMs information, and/or the like.

In one or more exemplary implementations, the monitoring service 104 continually analyzes the current aircraft status information with respect to the remainder of the flight plan to verify or otherwise confirm that the aircraft 106 will be able to traverse the downpath waypoints and land at the intended destination airport or other destination landing location based on the current altitude, the current heading, the current speed, and current geographic location while factoring in the current amount of available energy remaining (e.g., fuel and/or battery level), the current aircraft configuration (e.g., the current engine or rotor state, the current drag configuration, and/or the like), and the supplemental information obtained from the external data sources 110 pertaining to the remainder of the flight plan route (e.g., the anticipated meteorological conditions, the anticipated air traffic, the anticipated airspace restrictions, and/or the like). In such implementations, the monitoring service 104 may automatically detect or otherwise identify an anomalous condition when the probability of the aircraft 106 reaching the intended destination falls below a threshold probability level. Additionally, the monitoring service 104 may automatically detect or otherwise identify an anomalous condition based on the current aircraft status information, for example, when the current state of charge of a battery falls below a threshold value, the amount of fuel remaining falls below a threshold value, or other current state information is indicative of a potential mechanical event likely to impact the ability of the aircraft 106 to reach the intended destination. It should be noted that although the subject matter is described in the context of the monitoring service 104 automatically identifying an anomalous condition, in practice, the anomalous condition may also be manually identified or otherwise indicated by a vehicle operator. For example, a user of a control device 108 being utilized to operate the aircraft 106 may manipulate the user input device 134 to input or otherwise provide indication of an anomalous condition to the monitoring service 104 (e.g., by interacting with a GUI element of a GUI display presented at the control device 108).

Still referring to FIG. 2, in response to an anomalous condition with respect to continued operation of a vehicle along a current route of travel en route to an intended destination, the recovery process 200 automatically identifies or otherwise determines a plurality of different potential alternative travel plans from the current vehicle position to alternative destinations in accordance with different potential salvage strategies (task 208). For example, as described above, in an aviation context, different potential salvage strategies may be predefined, with a respective salvage strategy being configured to minimize, maximize, optimize or otherwise prioritize different recovery or salvage criteria or combinations thereof in a manner that is distinct or otherwise different from other ones of the potential salvage strategies. Based on the respective recovery or salvage criteria being optimized for a given salvage strategy, the monitoring service 104 may identify a different alternative destination and a different alternative route to that alternative destination that are cooperatively configured to optimize the respective recovery or salvage criteria.

For example, in the context of a UAM or UAV application, a vehicle recovery salvage strategy may be defined to maximize probability of landing the aircraft 106 while minimizing probability of damaging the aircraft 106, for example, by identifying an alternative landing location within range of the aircraft 106 (e.g., based on the amount of fuel or battery remaining in relation to the current aircraft altitude, speed and heading) that can be reached while also minimizing potential energy at landing (e.g., by minimizing vertical speed, weight, and/or the like upon reaching the alternative destination). In this regard, the monitoring service 104 may analyze the potential landing locations within range of the aircraft 106 to automatically select or otherwise identify an alternative landing location that is most likely to be safest based on current and/or forecasted meteorological conditions, current and/or forecasted air traffic, airspace restrictions, terrain data, obstacle data and/or historical data associated with the respective landing locations, the current aircraft configuration or capabilities, and/or the like. After identifying the alternative landing location for the vehicle recovery salvage strategy, the monitoring service 104 then automatically determines a corresponding alternative flight plan for reaching that alternative landing location utilizing the current aircraft status information in concert with the meteorological information, air traffic information, airspace restrictions, terrain data, obstacle data and/or the like to construct a flight path from the current aircraft location to the alternative landing location that minimizes the potential energy upon reaching the alternative landing location. Additionally, in some implementations where payload information is available and the monitoring service 104 identifies or otherwise determines that the payload should be jettisoned along the route, the monitoring service 104 may automatically identify a potential payload jettisoning location and construct the alternative flight plan route to traverse that payload jettisoning location en route to the alternative landing location to facilitate jettisoning payload and minimizing gross weight upon reaching the alternative landing location.

As another example, a payload recovery salvage strategy may be defined to maximize probability of securing and recovering the payload and minimizing probability of damaging the payload rather than minimizing damage to the aircraft 106. In this regard, the monitoring service 104 may analyze the potential landing locations within range of the aircraft 106 to automatically select or otherwise identify an alternative landing location that is most suitable for landing the aircraft and/or jettisoning the payload in a manner that minimizes the probability of damage to the payload based on the weight, type, content or other information pertaining to the payload in concert with the current and/or forecasted meteorological conditions, current and/or forecasted air traffic, airspace restrictions, terrain data, obstacle data and/or historical data associated with the respective landing or jettisoning locations, the current aircraft configuration or capabilities, and/or the like. After identifying the alternative landing location for the payload recovery salvage strategy, the monitoring service 104 then automatically determines a corresponding alternative flight plan for reaching that alternative landing location from the current aircraft location in a manner that minimizes travel time or otherwise maximizes viability or probability of recovering the payload.

As another example, a mission-based recovery salvage strategy may be defined to maximize probability of completing or executing one or more objectives associated with the original flight plan. In this regard, the monitoring service 104 may analyze the potential landing locations within range of the aircraft 106 to automatically select or otherwise identify an alternative landing location that is closest to the originally intended destination that achieves a desired tradeoff or combination of securing the aircraft and/or securing the payload. For example, the monitoring service 104 may analyze the potential landing locations within range of the aircraft 106 to automatically select or otherwise identify an alternative landing location that minimizes the distance from the original destination landing location while achieving a probability of recovering the aircraft 106 and/or a probability of recovering the payload at or above a threshold level.

It should be noted that the foregoing examples are not exhaustive and are not intended to be limiting. In practice, any number of different recovery or salvage criteria may be utilized to define and prioritize different parameters when identifying, selecting and constructing different alternative routes to different alternative destinations, and the subject matter described herein is not limited to any particular type, number or combination of potential recovery salvage strategies. For example, alternative recovery salvage strategies may be configured to minimize travel time from the location of the operator (or control device 108) to the respective alternative destination location, minimizing energy consumption, minimizing distance from the original departure location, minimizing distance from the location of the operator and/or the like. Moreover, in addition to primary recovery or salvage criteria being optimized, any number of additional secondary criteria may be utilized to score or rank potential destinations to select or otherwise identify the alternative destination for a respective salvage strategy. For example, when two or more landing locations achieve the same probability of recovering the aircraft for purposes of a vehicle recovery salvage strategy, the respective one of the landing locations selected for use for that strategy may be selected or otherwise identified based on the relative distance from the originally planned destination, the relative distance from the operator, the amount of energy consumption required and/or the like. In this regard, there are any number of potential parameters, variables or factors that may be utilized to score, rank or otherwise select alternative destinations, and the subject matter described herein is not limited to any particular scoring scheme or implementation.

Still referring to FIG. 2, after identifying the different potential alternative travel plans corresponding to different potential salvage strategies, the recovery process 200 continues by calculating or otherwise determining values for one or more performance metrics associated with the respective salvage strategy (task 210). In this regard, based on the current aircraft state, the available supplemental information from the connected data sources 110, and historical data 114, the monitoring service 104 calculates or otherwise predicts a probability of one or more potential outcomes associated with executing the alternative flight plan and landing at the alternative landing location associated with the respective salvage strategy. For example, for each salvage strategy, the monitoring service 104 may calculate or otherwise determine the probability of the aircraft 106 landing successfully at the alternative landing location without exceeding a threshold level of damage to the aircraft 106. In a similar manner, the monitoring service 104 may calculate or otherwise determine the probability of the payload being jettisoned at a jettison location or otherwise delivered to the alternative landing location without exceeding a threshold level of damage to the payload. In some implementations, machine learning, artificial intelligence (AI) techniques or other modeling based on historical data 114 corresponding to prior flights may be utilized to calculate or otherwise determine values for performance metrics as a function of an input aircraft state and other supplemental information, and the subject matter described herein is not limited to any particular manner or technique for probabilistically determining the likelihood of a particular outcome with respect to a particular alternative flight plan or salvage strategy. For example, the historical data 114 may include built-in test equipment (BITE) data, engine health profile data, maintenance data, flight data recorder (FDR) data, cockpit data recorder (CDR) data, and other data associated with a respective flight that may be captured and recorded in a time-series in association with the respective outcomes for that particular flight or particular aircraft as part of post-flight analytics. The historical data 114 may be utilized to train or develop a model that allows scoring and ranking past flight scenarios similar to the current flight based on similarity to the current status information for the aircraft with the desired outcome (e.g., safety, state of aircraft after landing, state of payload after jettisoning and/or landing, remaining battery level or fuel remaining after landing, emergency landing location, and/or the like). The current state of the aircraft 106 may be input or otherwise provided to the resulting model to calculate or otherwise determine the probability of particular outcomes in a manner that is influenced by similar prior flights that encountered a state substantially similar to the current state of the aircraft 106 within a threshold degree of similarity.

After determining performance metrics associated with the different salvage strategies, the recovery process 200 generates or otherwise provides graphical indicia of the different salvage strategies and their associated performance metric values to a vehicle operator or other user, and thereafter configures the vehicle to utilize and execute the alternative travel plan associated with a selected one of the different salvage strategies (tasks 212, 214). In this regard, the monitoring service 104 may transmit or otherwise provide data, commands, code or other instructions to the control device 108 over a communications network that are configurable to cause the processing system 130 to generate graphical indicia of the different salvage strategies and their associated performance metrics on the display device 132. For example, the monitoring service 104 and/or processing system 130 may generate a selectable GUI element associated with a respective salvage strategy that is displayed adjacent to the performance metrics associated with the respective salvage strategy. In response to selection of the selectable GUI element, the monitoring service 104 may be configurable to cause the processing system 130 to dynamically update the GUI display at the display device 132 to depict a graphical representation of the alternative flight plan and resulting alternative landing location associated with the selected salvage strategy to allow the operator to review and analyze the proposed flight plan. When the operator identifies a salvage strategy desired to be executed, the operator may select or otherwise manipulate a GUI element to activate or otherwise enable the alternative flight plan. In response to user selection to activate a particular salvage strategy, in exemplary implementations, the monitoring service 104 transmits or otherwise provides (either directly over a communications network or indirectly via the control device 108) data, commands, code or other instructions to one or more avionics systems 112 at the aircraft 106 to automatically update the flight plan and other automated or autonomous functionality at the aircraft 106 to incorporate or otherwise utilize the alternative flight plan in lieu of a preexisting flight plan. In this manner, the monitoring service 104 may automatically configure the avionics system(s) 112 onboard the aircraft 106 to implement the alternative flight plan associated with the selected salvage strategy to deviate from the prior flight plan and automatically and autonomously fly the aircraft 106 to the alternative landing location associated with the selected salvage strategy.

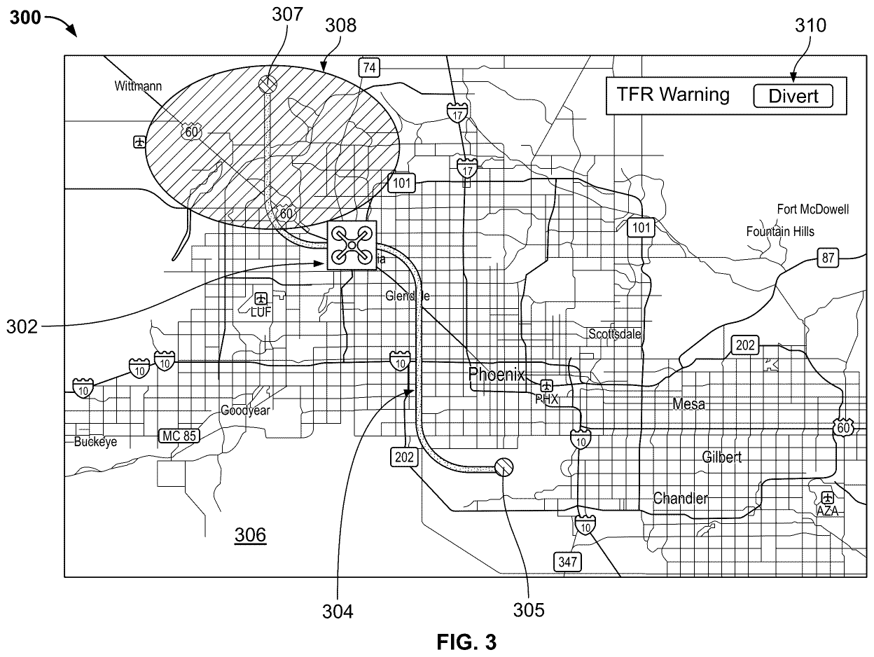

FIGS. 3-6 depict an exemplary sequence of GUI displays suitable for presentation on a display device, such as the display device 132 at the control device 108, in connection with an exemplary implementation of the recovery process 200 of FIG. 2. Referring to FIGS. 3-6, with continued reference to FIGS. 1-2, FIG. 3 depicts an exemplary navigational map graphical user interface (GUI) display 300 that may be displayed, rendered, or otherwise presented by the processing system 130 on the display device 132 at the control device 108. The navigational map GUI display 300 includes a graphical representation of the aircraft 302 with respect to a graphical representation of a portion of the route 304 defined by a flight plan for the aircraft 106 from a departure location 305 to a destination location 307. The graphical representation of the route 304 is overlaid or rendered on top of a background 306, which is generally realized as a graphical representation of the terrain, topology, navigational reference points, airspace designations and/or restrictions, or other suitable items or points of interest corresponding to the currently displayed area of the navigational map GUI display 300, which may be maintained in a terrain database, a navigational database, a geopolitical database, or another suitable database. In this regard, the aircraft symbology 302 is depicted at a displayed position with respect to the flight plan route 304 and terrain background 306 corresponding to the current geographic location of the aircraft 106. It should be noted that although FIG. 3 depicts a top view (e.g., from above the aircraft) of the navigational map GUI display 300 (alternatively referred to as a lateral map or lateral view), in practice, alternative embodiments may utilize various perspective views, such as side views, three-dimensional views (e.g., a three-dimensional synthetic vision display), angular or skewed views, and the like.

In practice, the navigational map GUI display 300 may be associated with the movement of the aircraft 106 and dynamically update as the aircraft 106 travels in a manner that accurately reflects the current (e.g., instantaneous or substantially real-time) real-world positioning of the aircraft 106 relative to the earth. For purposes of explanation, the subject matter is described herein primarily in the context of an implementation where the navigational map GUI display 300 is oriented in a cardinal direction (e.g., oriented north-up so that moving upward on the navigational map GUI display 300 corresponds to traveling northward); however, in alternative implementations, the orientation of the navigational map GUI display 300 may be track-up or heading-up (i.e., aligned such that the aircraft symbology is always traveling in an upward direction and the background 306 adjusted accordingly).

Referring to FIG. 3 with reference to FIG. 2, in response to the monitoring service 104 receiving supplemental information from a connected data source 110 indicative of a temporary flight restriction associated with the destination location 307 or otherwise encompassing the destination location 307, the monitoring service 104 may automatically identify an anomalous condition with respect to continued execution of the flight plan route 304 (e.g., at task 206) and automatically provide corresponding data, commands, code or other instructions to the control device 108 to cause the processing system 130 to generate, render or otherwise display a graphical representation 308 of the temporary flight restriction along with a graphical indication 310 of an anomalous condition that may require a diversion from the original flight plan route 304. In this regard, the monitoring service 104 may cause the processing system 130 to display a selectable GUI element 310 that is selectable by the user or other operator of the control device 108 to view different potential salvage strategies for the aircraft 106.

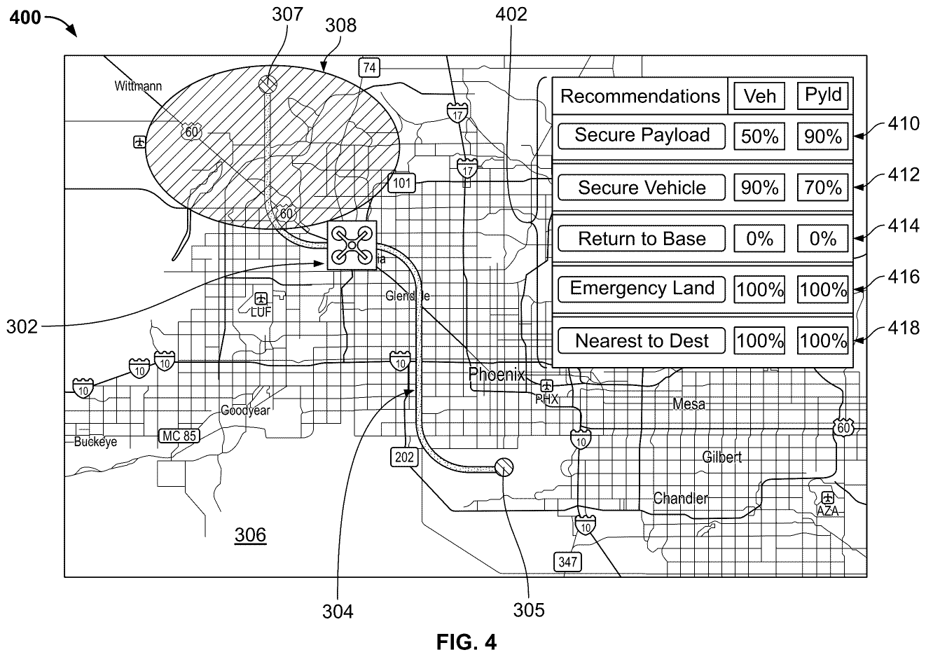

Turning to FIG. 4, in response to user selection of the GUI element 310, the processing system 130 may provide a request for salvage strategy information to the monitoring service 104, which, in turn, causes the monitoring service 104 to transmit or otherwise provide data, commands, code or other instructions to the control device 108 to cause the processing system 130 to generate an updated GUI display 400 that includes a window, list box or similar GUI element 402 that includes a listing of the different potential salvage strategies identified by the monitoring service 104 and their associated performance metric values calculated by the monitoring service 104 (e.g., tasks 208, 210, 212). In the illustrated implementation, the salvage strategy window 402 includes different selectable GUI elements 410, 412, 414, 416, 418 (e.g., buttons, hyperlinks or the like) corresponding to the different potential salvage strategies, with textual labels identifying the particular salvage strategy and the performance metric values associated therewith. In this regard, FIGS. 4-6 depict an example scenario where the monitoring service 104 identifies a payload recovery salvage strategy (“Secure Payload”), a vehicle recovery salvage strategy (“Secure Vehicle”), a return to departure location salvage strategy (“Return to Base”), an emergency landing salvage strategy (“Emergency Land”), and a nearest to destination salvage strategy (“Near to Dest”), with the calculated values for the probability of landing and recovering the aircraft 106 with less than a threshold level of damage and the probability of landing and recovering the payload with less than a threshold level of damage for the respective salvage strategy being displayed in association with the respective selectable GUI elements 410, 412, 414, 416, 418.

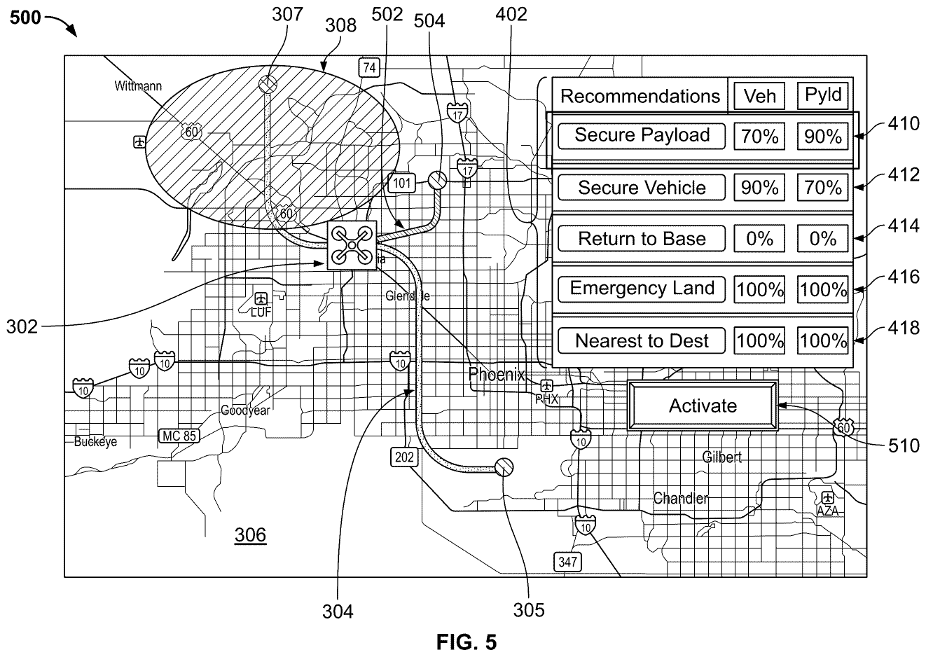

Referring now to FIG. 5, in response to selection of a GUI element 410 associated with a payload recovery salvage strategy (“Secure Payload”), the processing system 130 may provide a request for payload recovery salvage strategy information to the monitoring service 104, which, in turn, causes the monitoring service 104 to transmit or otherwise provide data, commands, code or other instructions to the control device 108 to cause the processing system 130 to generate an updated alternative route preview GUI display 500 that includes a graphical representation of the alternative flight plan route 502 to the alternative destination landing location 504 associated with the payload recovery salvage strategy along with a button or similar selectable GUI element 510 to activate or otherwise enable the currently selected salvage strategy. As described above, the alternative destination landing location 502 may be identified by the monitoring service 104 selecting an appropriate landing location within range of the aircraft 106 based on the weight, size and/or type of payload and potentially other factors or requirements associated with the payload (e.g., nonresidential areas and/or the like) that has the highest scoring or ranking relative to other potential landing locations for the payload (e.g., based on distance from the intended destination landing location 307, distance from the departure location 305, and/or the like).

As described above, for the payload recovery salvage strategy, priority will be given to the payload rather than the aircraft 106, with the alternative flight plan and alternative landing location being selected based on the weight, size, type and/or other payload restrictions and configuring the aircraft 106 to operate beyond its load factor to increase flight stability and maneuverability at the expense of operating costs or degradation of the aircraft 106. In this regard, the alternative flight plan may be configured to operate the aircraft 106 in a manner that degrades the battery or other energy source (e.g., by operating with a higher battery discharge rate for increased power consumption) or potentially degrades mechanical components of the aircraft 106 (e.g., by increasing the load factor) to increase the probability of recovering the payload at the potential expense of degrading airworthiness of the aircraft 106. For example, the alternative flight plan for the payload recovery salvage strategy may include one or more complex maneuvers for purposes of jettisoning the payload, which, in turn, could consequently increase power consumption or impact airworthiness of the aircraft 106. As another example, the alternative flight plan for the payload recovery salvage strategy may entail increasing the load factor to run motors or other actuators associated with the rotors or other flight control components of the aircraft 106 at higher revolutions per minute or in a manner that consumes an increased amount of motor current for purposes of preserving the payload (e.g., organ shipments or other medical related flights, or the like) by reaching a particular location for jettisoning the payload or landing with the payload more expeditiously while potentially increasing degradation or maintenance costs associated with the motors, actuators or other components of the aircraft 106.

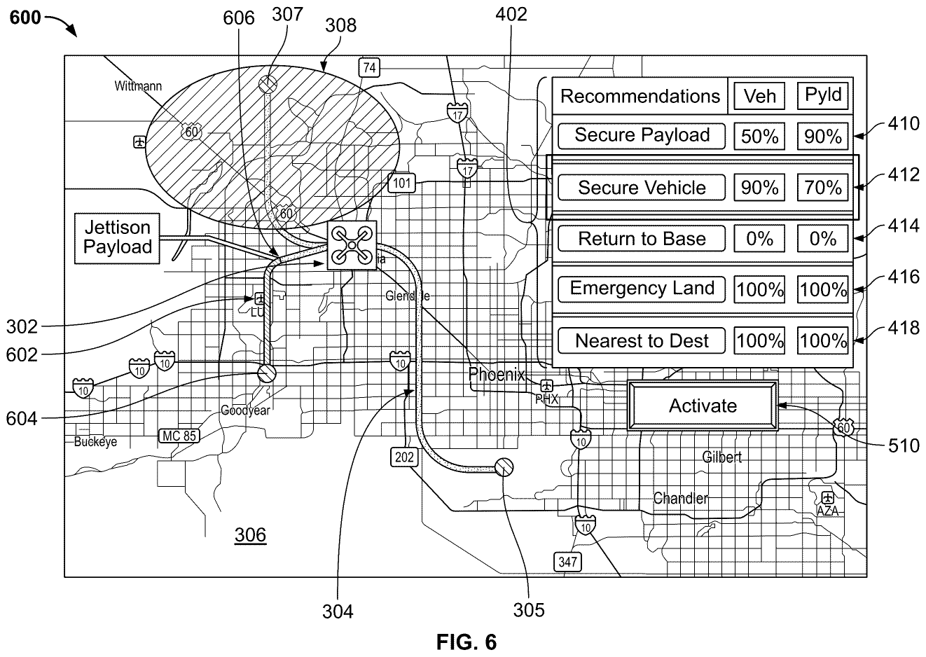

Referring to FIG. 6, in response to selection of a GUI element 412 associated with a vehicle recovery salvage strategy (“Secure Vehicle”), the processing system 130 may provide a request for vehicle recovery salvage strategy information to the monitoring service 104, which, in turn, causes the monitoring service 104 to transmit or otherwise provide data, commands, code or other instructions to the control device 108 to cause the processing system 130 to generate an updated alternative route preview GUI display 600 that includes a graphical representation of the alternative flight plan route 602 to the alternative destination landing location 604 associated with the vehicle recovery salvage strategy. As described above, the alternative destination landing location 602 may be identified by the monitoring service 104 selecting an appropriate landing location within range of the aircraft 106 based on the weight, size and/or type of aircraft 106 and potentially other factors or requirements associated with the aircraft 106 that has the highest scoring or ranking relative to other potential landing locations for the aircraft 106. In this regard, FIG. 6 depicts an alternative flight plan route 602 that traverses a jettisoning location 606 where the payload is to be jettisoned while en route to the alternative destination landing location 604 identified for the vehicle recovery salvage strategy. As described above, for the vehicle recovery salvage strategy, priority will be given to the aircraft 106 rather than the payload, with the alternative flight plan and alternative landing location being selected based on ability to safely land the aircraft 106 and maintain airworthiness by jettisoning noncritical or disposable payloads to reduce strain on the motors, rotors or other flight control components of the aircraft 106 and reduce battery discharge rate at the potential expense of payload viability.

In response to selection of the GUI element 510, the processing system 130 may provide indication of the selected salvage strategy, which, in turn, causes the monitoring service 104 to transmit or otherwise provide data, commands, code or other instructions for one or more avionics systems 112 to execute or otherwise implement the alternative flight plan route 602 to the alternative destination landing location 604 in place of the remainder of the original flight plan. For example, the monitoring service 104 may communicate with an FMS, autopilot or other avionics system 112 onboard the aircraft 106 to modify the active flight plan to include the waypoints or other navigational reference points associated with the alternative flight plan route 602 in lieu of any upcoming waypoints or other navigational reference points of the original flight plan route, such that the avionics system(s) 112 autonomously operate the aircraft 106 to divert from the original flight plan route towards the jettisoning location 606 before continuing onward to the alternative destination landing location 604. In this manner, the desired salvage strategy identified by the user or other operator of the control device 108 may be automatically implemented at the aircraft 106 in response to user selection of the GUI element 510 without requiring the user or operator to manually interact with the onboard avionics systems 112 to reprogram the aircraft 106.

By virtue of the subject matter described herein, a cloud-based monitoring service 104 supporting the recovery process 200 is capable of providing an aircraft operator or other user of different “what-if” scenarios, depicting different potential strategies for salvaging or otherwise recovering the aircraft 106 and/or payload in response to an anomalous condition that inhibits the ability of the aircraft 106 to execute an original flight plan. In this regard, the resulting GUI displays depicting the different potential salvage strategies and their associated performance metrics may improve situational awareness and associated decision-making, thereby improving safety and providing the operator with greater control over managing potential degradation of the aircraft 106, the viability of the payload, and potentially other factors or preferences of the respective operator. Additionally, by virtue of the cloud-based monitoring service 104 automatically generating corresponding flight plans, the aircraft 106 may be quickly reprogrammed to execute a desired salvage strategy without requiring an operator to manually interface or interact with the onboard avionics systems 112 or manually attempt to execute the alternative flight plan.

As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an ASIC.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of assisting operation of a vehicle, the method comprising:
obtaining, via one or more systems onboard the vehicle, status information indicative of a current state of the vehicle en route to a destination;
for a respective salvage strategy of a plurality of salvage strategies:
determining an alternative destination for the vehicle different from the destination based at least in part on the current state of the vehicle and one or more salvage criteria associated with the respective salvage strategy;
determining an alternative route to the alternative destination based at least in part on the current state of the vehicle; and
calculating one or more recovery performance metrics associated with the alternative route based at least in part on the current state of the vehicle; and
providing, on a graphical user interface (GUI) display associated with the vehicle, graphical indicia of the respective one or more recovery performance metrics associated with the respective salvage strategies of the plurality of salvage strategies.

2. The method of claim 1, wherein determining the alternative destination comprises identifying the alternative destination within a current range of the vehicle from a current geographic location that optimizes a salvage criterion associated with the respective salvage strategy, wherein the salvage criterion is different from a second salvage criterion optimized for a second salvage strategy of the plurality of salvage strategies.

3. The method of claim 2, wherein the salvage criterion comprises a viability of the vehicle, wherein determining the alternative route comprises identifying a location along the alternative route for jettisoning a payload of the vehicle prior to the alternative destination.

4. The method of claim 1, further comprising automatically configuring the vehicle to execute a selected salvage strategy of the plurality of salvage strategies in response to user selection of a GUI element on the GUI display.

5. The method of claim 1, wherein providing the graphical indicia comprises displaying a window comprising a listing of the plurality of salvage strategies and the respective one or more recovery performance metrics associated with the respective salvage strategies of the plurality of salvage strategies.

6. The method of claim 5, wherein providing the graphical indicia further comprises providing a selectable GUI element for each salvage strategy of the plurality of salvage strategies in the listing within the window.

7. The method of claim 6, further comprising providing an alternative route preview GUI display comprising a graphical representation of the alternative route to the alternative destination associated with the respective salvage strategy in response to user selection of the selectable GUI element associated with the respective salvage strategy.

8. The method of claim 7, further comprising automatically configuring the vehicle to execute the alternative route to the alternative destination in response to user selection of a GUI element on the alternative route preview GUI display.

9. The method of claim 8, wherein the vehicle comprises an aircraft and automatically configuring the vehicle comprises a cloud-based monitoring service automatically commanding a flight management system (FMS) onboard the aircraft to utilize an alternative flight plan comprising the alternative route to the alternative destination in lieu of an original flight plan to the destination.

10. The method of claim 9, wherein:
the respective salvage strategy comprises a payload recovery salvage strategy; and
determining the alternative route to the alternative destination comprises determining the alternative route to the alternative destination using an aircraft configuration corresponding to an increased load factor for the aircraft.

11. The method of claim 9, wherein:
the respective salvage strategy comprises a vehicle recovery salvage strategy; and
determining the alternative route to the alternative destination comprises determining the alternative route to the alternative destination that traverses a jettisoning location for jettisoning a payload of the aircraft en route to the alternative destination.

12. A computer-readable medium having computer-executable instructions stored thereon that, when executed by a processing system of a cloud-based computing system, cause the processing system to:
obtain status information from one or more systems onboard a vehicle, wherein the status information is indicative of a current state of the vehicle en route to a destination;
for a respective salvage strategy of a plurality of salvage strategies:
determine an alternative destination for the vehicle different from the destination based at least in part on the current state of the vehicle and one or more salvage criteria associated with the respective salvage strategy;
determine an alternative route to the alternative destination based at least in part on the current state of the vehicle; and
calculate one or more recovery performance metrics associated with the alternative route based at least in part on the current state of the vehicle; and
provide graphical indicia of the respective one or more recovery performance metrics associated with the respective salvage strategies of the plurality of salvage strategies on a graphical user interface (GUI) display associated with the vehicle.

13. The computer-readable medium of claim 12, wherein the instructions are configurable to cause the processing system to optimize a salvage criterion associated with the respective salvage strategy to identify the alternative destination within a current range of the vehicle from a current geographic location of the vehicle, wherein the salvage criterion is different from a second salvage criterion optimized for a second salvage strategy of the plurality of salvage strategies.

14. The computer-readable medium of claim 13, wherein the salvage criterion comprises a viability of the vehicle and the instructions are configurable to cause the processing system to identify a location along the alternative route for jettisoning a payload of the vehicle prior to the alternative destination.

15. The computer-readable medium of claim 12, wherein the instructions are configurable to cause the processing system to automatically configure the vehicle to execute a selected salvage strategy of the plurality of salvage strategies in response to user selection of a GUI element on the GUI display.

16. The computer-readable medium of claim 12, wherein the instructions are configurable to cause the processing system to display a window comprising a listing of the plurality of salvage strategies and the respective one or more recovery performance metrics associated with the respective salvage strategies of the plurality of salvage strategies.

17. The computer-readable medium of claim 16, wherein the instructions are configurable to cause the processing system to provide a selectable GUI element for each salvage strategy of the plurality of salvage strategies in the listing within the window.

18. The computer-readable medium of claim 17, wherein the instructions are configurable to cause the processing system to provide an alternative route preview GUI display comprising a graphical representation of the alternative route to the alternative destination associated with the respective salvage strategy in response to user selection of the selectable GUI element associated with the respective salvage strategy.

19. The computer-readable medium of claim 18, wherein the instructions are configurable to cause the processing system to automatically configure the vehicle to execute the alternative route to the alternative destination in response to user selection of a GUI element on the alternative route preview GUI display.

20. A cloud-based computing system comprising:
a data storage element to maintain one or more salvage criteria associated with respective ones of a plurality of salvage strategies; and
a processing system coupled to the data storage element to provide a monitoring service, wherein the monitoring service is configurable to:
obtain status information indicative of a current state of a vehicle en route to a destination from one or more systems onboard the vehicle;
for a respective salvage strategy of the plurality of salvage strategies:
determine an alternative destination for the vehicle different from the destination based at least in part on the current state of the vehicle and the one or more salvage criteria associated with the respective salvage strategy;
determine an alternative route to the alternative destination based at least in part on the current state of the vehicle; and
calculate one or more recovery performance metrics associated with the alternative route based at least in part on the current state of the vehicle; and
provide graphical indicia of the respective one or more recovery performance metrics associated with the respective salvage strategies of the plurality of salvage strategies on a graphical user interface (GUI) display associated with the vehicle.
